(19) United States
(12) Patent Application Publication
(10) Pub. No.: US 2012/0017282 A1
(43) Pub. Date: Jan. 19, 2012

(54) METHOD AND APPARATUS FOR PROVIDING DRM SERVICE

(75) Inventors: Bo-Gyeong KANG, Seoul (KR); Byung Rae LEE, Seoul (KR)

(73) Assignee: Samsung Electronics Co., Ltd.

(21) Appl. No.: 13/185,869

(22) Filed: Jul. 19, 2011

(30) Foreign Application Priority Data
Jul. 19, 2010 (KR) 10-2010-0069743

(51) Int. Cl. G06F 21/24; G06F 15/173

(52) U.S. Cl. 726/26

(57) ABSTRACT

A method and apparatus are provided for providing a DRM service in a user terminal apparatus providing an adaptive streaming service. Content protection information is received that includes information about multiple DRM systems applied to specific content provided using the adaptive streaming service. A specific DRM system is selected from among the multiple DRM systems. A license corresponding to the specific DRM system is acquired. The license includes an encryption key capable of decrypting the specific content. The specific content is decrypted using the acquired license.

### PRIORITY

This application claims priority under 35 U.S.C. §119(a) to a Korean Patent Application filed in the Korean Intellectual Property Office on Jul. 19, 2010 and assigned Serial No. 10-2010-0069743, the entire disclosure of which is hereby incorporated by reference.

### BACKGROUND OF THE INVENTION

1. Field of the Invention

The present invention relates generally to Digital Rights Management (DRM), and more particularly, to a method and apparatus for providing a DRM service in a user terminal regardless of DRM system types.

2. Description of the Related Art

In the current digital era, it is very important to determine how to distribute digital content on user terminals, such as televisions, computers, and portable devices.

The technology of a DRM service continuously manages and protects intellectual property rights of digital content using encryption technology. More specifically, the DRM service securely delivers a variety of content from a Content Provider (CP) to users, and preventing those users from illegally distributing the content. This DRM service may protect information throughout the entire process of creating, distributing, using and discarding the digital content, and may also protect the rights and privileges of online and offline users.

In order for a user to enjoy content to which the DRM service is applied (hereinafter referred to as ‘DRM content’) on a user terminal, the user terminal should first access a system providing the DRM content, and download DRM content, metadata for the DRM content, and a license thereof. The metadata is data in which information about the DRM content is stored, and the license is data having information that specifies an encryption key used to decrypt encrypted DRM content, and access rights (e.g., the number of accesses, period, etc.) to DRM content. If both the DRM content and the license are stored in a user terminal through the above process, a user of the user terminal is allowed to access the DRM content. To allow the user to access the DRM content, a DRM agent capable of running a relevant DRM solution should be installed in the user terminal.

Various different DRM systems coexist in the current telecommunications market. For example, DRM systems may include an Open Mobile Alliance (OMA) DRM system, a Marlin DRM system, a Widevine DRM system, etc. These DRM systems are common in that they provide digital content after encryption, and grant access rights to the digital content, i.e., they use licenses. However, the DRM systems are different in the language or format used to represent the licenses, and are also different in the message format used to run the DRM service. These differences can cause incompatibility problems that occur when the DRM system used by the CP providing DRM content is different from the DRM system supported by the user terminal.

Digital content may be provided to user terminals by various different delivery schemes. One such delivery scheme is a streaming service for providing digital content data in real time. The DRM technology may be applied to this streaming service. The DRM technology may also be applied to an adaptive streaming service that automatically adjusts a streaming rate or a bitrate depending on the access environment, to optimize the transfer rate.

The adaptive streaming service, which optimizes the bitrate by analyzing the network environment of the users, allows a user terminal to select units of content divided into segments based on a Hyper Text Transfer Protocol (HTTP), and play them according to the situation. This makes it possible for its user to access the content seamlessly and without delay.

The terms used in the adaptive streaming service may be defined as follows:
Content: Creations like movies, music and news, and a storage form thereof;
Content Component: Components constituting content (e.g., video, audio, and captions); and
Representation: Representation form of content. For example, low-quality and high-quality representations may exist, but their contents are the same.

The adaptive streaming service provides representations obtained by encoding the same content or content components with different conditions (for example, different network bandwidths, resolutions, codecs, etc.). In addition, the adaptive streaming service divides the entire length of content into multiple equivalent periods, divides the periods into segments (segmentation) of a sufficiently short time (e.g., about 1 to 10 seconds), and provides Multimedia Presentation Description (MPD) information, serving as a manifest file, in which a file name, a sequence number, a start time, a length, etc. of each segment are specified.

A segment includes an initialization segment having information for decoder configuration provided to properly decode its representation, and media segments including segmented content components.

A user terminal first receives MPD information and determines which representation is included in it. Thereafter, the user terminal checks performance, capability, network speed, etc. of a client device, selects a proper representation, downloads its segments in sequence, and starts playing them.

If there is a change in the mutable variables like a network bandwidth, i.e., if a network speed increases, the user terminal selects and plays segments of a representation made with a higher network bandwidth. As a result, although the quality may vary depending on the network speed, the content may be played seamlessly.

Generally, when the DRM technology is applied to the adaptive streaming service, a maximum of 1 DRM system is supported on a streaming service or streaming content basis in a fixed manner. A content service server providing streaming service transmits MPD information represented in XML to user terminals.

The MPD information, which includes basic information about the content being or to be serviced, may include information about the type of the service, a valid period of the service, etc. The MPD information includes information about one or more representations. The representation information indicates if DRM is applied to the streaming service, and includes identification information for the content provided by the streaming service, and address information by which the content may be acquired.

A user terminal parses MPD information, and selects representation information having a proper bitrate taking the network bandwidth into consideration in each period of streaming data.

Accordingly, the user terminal checks a segment Uniform Resource Identifier (URI) and content protection information, included in the representation information. The user terminal additionally acquires the license for DRM applied data from the representation information, decrypts encrypted segments, and plays the content.

FIG. 1 illustrates an XML structure of MPD information, and FIG. 2 illustrates representation information defined in a period in an MPD. FIGS. 1 and 2 illustrate the information based on an MPD schema used in an HTTP Adaptive Streaming (HAS) system.

Referring to FIG. 2, the representation information includes bandwidth information 10, to which the representation is applied. The representation information also includes content protection information 20 indicating if DRM is applied and indicating information about the applied DRM system. The representation information further includes segment information 30 indicating identification information and acquisition address information for each segment constituting the content provided by the streaming service.

The above-described known technology may have the following shortcomings.

First, the known technology may not support multiple DRM systems because a maximum of 1 DRM system is represented in each representation.

Second, if no DRM system is installed in a user terminal in advance, a client device may not decrypt the encrypted segments even though a bandwidth of its bitrate is available.

Third, there is no way to support different security levels and protection systems depending on the bitrate types (high-resolution images and low-resolution images).

Fourth, the user terminal may not determine if content being or to be serviced on the MPD information level is protected.

### SUMMARY OF THE INVENTION

The present invention has been made to address at least the above problems and/or disadvantages and to provide at least the advantages described below. Accordingly, an aspect of the present invention provides a method and apparatus capable of providing content supporting multiple DRM systems in providing an adaptive streaming service.

Another aspect of the present invention provides a method and apparatus capable of decrypting and playing encrypted streaming data when no DRM system is installed in a user terminal.

Another aspect of the present invention provides a method and apparatus capable of securely ensuring a wider variety of content distribution by making it possible to designate different DRM systems to meet different security requirements depending on the content qualities.

In accordance with one aspect of the present invention, a method is provided for providing a DRM service in a user terminal apparatus providing an adaptive streaming service. Content protection information is received that includes information about multiple DRM systems applied to specific content provided using the adaptive streaming service. A specific DRM system is selected from among the multiple DRM systems. A license corresponding to the specific DRM system is acquired. The license includes an encryption key capable of decrypting the specific content. The specific content is decrypted using the acquired license.

In accordance with another aspect of the present invention, a user terminal apparatus is provided for providing an adaptive streaming service and a DRM service. The user terminal apparatus includes a transceiver for receiving content protection information including information about multiple DRM systems applied to specific content provided using the adaptive streaming service. The user terminal apparatus also includes a DRM selector for selecting a specific DRM system from among the multiple DRM systems. The user terminal apparatus additionally includes a DRM agent for acquiring a license corresponding to the specific DRM system. The license includes an encryption key capable of decrypting the specific content. The user terminal apparatus further includes a decryptor for decrypting the specific content using the acquired license.

In accordance with an additional aspect of the present invention, a method is provided for providing a DRM service in a content service server providing an adaptive streaming service. MPD information is generated that includes content protection information, which includes information about multiple DRM systems applied to each of a plurality of representations corresponding to specific content provided using the adaptive streaming service. The MPD information is transmitted to at least one user terminal apparatus.

In accordance with a further aspect of the present invention, an apparatus is provided for providing a DRM service in a content service server providing an adaptive streaming service. The apparatus includes an MPD information generator for generating MPD information including content protection information, which includes information about multiple DRM systems applied to each of a plurality of representations corresponding to specific content provided using the adaptive streaming service. The apparatus also includes a communication unit for transmitting the MPD information to at least one user terminal apparatus.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a diagram illustrating general MPD information;

FIG. 2 is a diagram illustrating general representation information;

FIG. 3 is a diagram illustrating a configuration of a DRM service system, according to an embodiment of the present invention;

FIG. 4 is a diagram illustrating a structure of a DRM service server, according to an embodiment of the present invention;

FIG. 5 is a diagram illustrating a structure of a content service server, according to an embodiment of the present invention;

FIG. 6 is a diagram illustrating a structure of a user terminal, according to an embodiment of the present invention;

FIG. 7 is a diagram illustrating MPD information, according to an embodiment of the present invention;

FIG. 8 is a diagram illustrating the supporting of multiple DRM systems on a representation basis and a period basis, according to an embodiment of the present invention;

FIG. 9 is a diagram illustrating a method for managing encryption keys, according to an embodiment of the present invention;

FIGS. 10 and 11 are diagrams illustrating MPD information for supporting multiple DRM systems on a representation basis, according to an embodiment of the present invention;

FIG. 12 is a diagram illustrating an example of supporting multiple DRM systems on a representation basis and a period basis, according to an embodiment of the present invention;

FIG. 13 is a flow diagram illustrating an operation of a user terminal, according to an embodiment of the present invention; and

FIG. 14 is a diagram illustrating an operation of a DRM service provision system, according to an embodiment of the present invention.

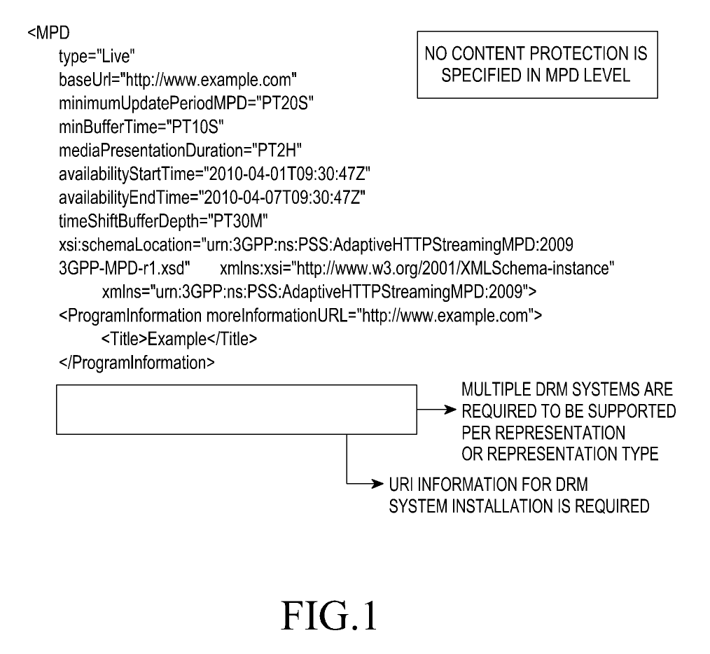

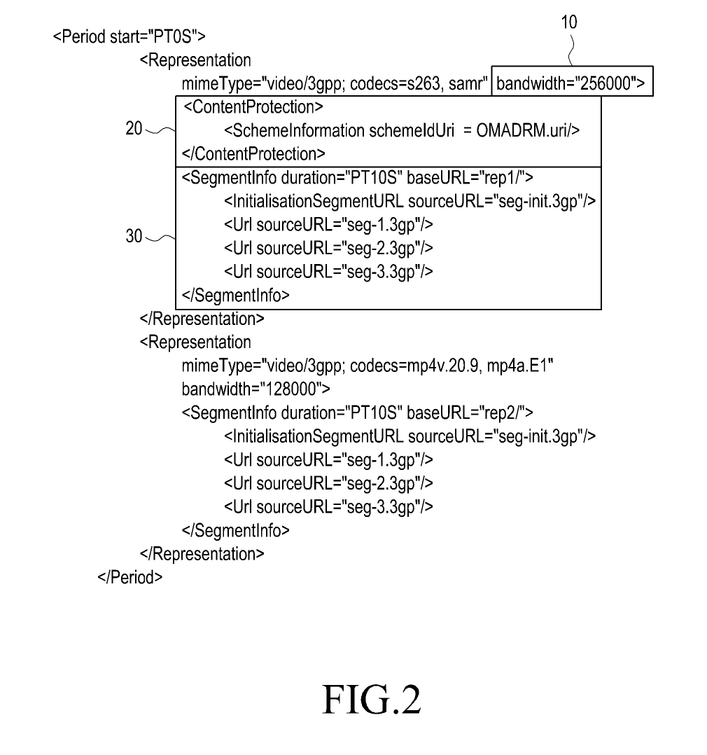

### DETAILED DESCRIPTION OF EMBODIMENTS OF THE PRESENT INVENTION

Embodiments of the present invention are described in detail below with reference to the accompanying drawings. The same or similar components may be designated by the same or similar reference numerals although they are illustrated in different drawings. In the following description, specific details such as detailed configuration and components are merely provided to assist the overall understanding of embodiments of the present invention. Detailed descriptions of constructions or processes known in the art may be omitted to avoid obscuring the subject matter of the present invention.

Embodiments of the present invention provide content, to which multiple DRM systems are applied, in providing an adaptive streaming service. Information about the multiple DRM systems applied to the content is provided together, and download information used to download at least one DRM system may also be provided.

Accordingly, a user terminal may acquire a license for content and play the content using a DRM agent of a DRM system installed in the user terminal in advance from among the multiple DRM systems applied to the content. Alternatively, the user terminal may download a specific DRM system module, install its associated DRM agent, and acquire the license using the DRM agent.

In addition, in providing an adaptive streaming service, embodiments of the present invention may apply multiple different DRM systems to periods divided from the entire length of content data, depending on the network bandwidth.

Accordingly, a user terminal may select a proper DRM system and acquire a license depending on the period and/or the current network bandwidth of the streaming data.

Embodiments of the present invention may apply one or more DRM systems to content to make it possible to acquire a different license depending on a user subscription level granted to a user terminal, and may also configure a license so that the user terminal may decrypt the content it has acquired according to a low subscription level, once it acquires a high-level subscription license.

In accordance with an embodiment of the present invention, to provide a DRM service, a user terminal apparatus for providing an adaptive streaming service may include: a process of receiving content protection information including information about multiple DRM systems applied to specific content provided by the adaptive streaming service; a process of selecting a specific DRM system from among the multiple DRM systems; a process of acquiring a license corresponding to the specific DRM system and including an encryption key by which the specific content may be decrypted; and a process of decrypting the specific content using the acquired license.

To acquire the license, the user terminal apparatus may: download a specific DRM system module based on download information included in the content protection information if the specific DRM system is not identical to a DRM system supported by the user terminal; install a DRM agent corresponding to the specific DRM system module using the specific DRM system module; and acquire a license by the DRM agent based on license acquisition information included in the content protection information.

In selecting the specific DRM system, the user terminal apparatus may: check a receive period (or a period to be received) in the specific content divided into multiple periods in accordance with the adaptive streaming service; check types of multiple DRM systems applied to the checked receive period based on the content protection information; and select a specific DRM system from among the multiple DRM systems applied to the checked period based on a selection criteria.

In selecting the specific DRM system, the user terminal apparatus may: check a current network bandwidth by monitoring a network state; check a receive period in the specific content divided into multiple periods in accordance with the adaptive streaming service; select a representation supporting the checked current network bandwidth from among multiple representations corresponding to the receive period; check types of multiple DRM systems applied to the selected representation based on the content protection information; select a specific DRM system from among the type-checked multiple DRM systems based on a selection criteria.

In selecting the specific DRM system, the user terminal apparatus may: check a current network bandwidth by monitoring a network state; check a receive period in the specific content divided into multiple periods in accordance with the adaptive streaming service; select a representation supporting the checked current network bandwidth and corresponding to a subscription level corresponding to the user terminal apparatus, from among multiple representations corresponding to the receive period; check types of multiple DRM systems applied to the selected representation based on the content protection information; and select a specific DRM system from among the type-checked multiple DRM systems based on a selection criteria.

Content corresponding to a representation corresponding to a subscription level lower than a subscription level corresponding to the user terminal apparatus among the presentations may be played using a second encryption key acquired using a first encryption key included in the acquired license.

The selection criteria may include at least one of a DRM system of a type supported by the user terminal apparatus, a DRM system preferred by the user terminal apparatus, and a DRM system preferred by a provider of the specific content.

The content protection information may be included in any one of a top node of MPD information and representation information.

In accordance with an embodiment of the present invention, a user terminal apparatus providing an adaptive streaming service and a DRM service, may include: a transceiver for receiving content protection information including information about multiple DRM systems applied to specific content provided using the adaptive streaming service; a DRM selector for selecting a specific DRM system from among the multiple DRM systems; a DRM agent for acquiring a license corresponding to the specific DRM system and including an encryption key by which the specific content may be decrypted; and a decryptor for decrypting the specific content using the acquired license.

The user terminal apparatus may further include a DRM installer for downloading a specific DRM system module based on download information included in the content protection information if the specific DRM system is not identical to a DRM system supported by the user terminal, and installing the DRM agent corresponding to the specific DRM system module using the specific DRM system module. The DRM agent may acquire a license based on license acquisition information included in the content protection information.

The user terminal apparatus may further include a representation selector for checking a receive period (or a period to be received) in the specific content divided into multiple periods in accordance with the adaptive streaming service. The DRM selector may check types of multiple DRM systems applied to the checked receive period based on the content protection information, and select a specific DRM system from among the multiple DRM systems applied to the checked period based on a selection criteria.

The user terminal apparatus may further include a bandwidth monitor for checking a current network bandwidth by monitoring a network state, and a representation selector for checking a receive period in the specific content divided into multiple periods in accordance with the adaptive streaming service, and selecting a representation supporting the checked current network bandwidth from among multiple representations corresponding to the receive period. The DRM selector may check types of multiple DRM systems applied to the selected representation based on the content protection information, and select a specific DRM system from among the type-checked multiple DRM systems based on a selection criteria.

The user terminal apparatus may further include a representation selector for checking a receive period in the specific content divided into multiple periods in accordance with the adaptive streaming service, and selecting a representation supporting the checked current network bandwidth and corresponding to a subscription level corresponding to the user terminal apparatus, from among multiple representations corresponding to the receive period. The DRM selector may check types of multiple DRM systems applied to the selected representation based on the content protection information, and select a specific DRM system from among the type-checked multiple DRM systems based on a selection criteria.

In accordance with an embodiment of the present invention, a content service server providing an adaptive streaming service, includes: an MPD information generator for generating MPD information including content protection information including information about multiple DRM systems applied to each of multiple representations corresponding to specific content provided using the adaptive streaming service; and a communication unit for transmitting the MPD information to at least one user terminal apparatus.

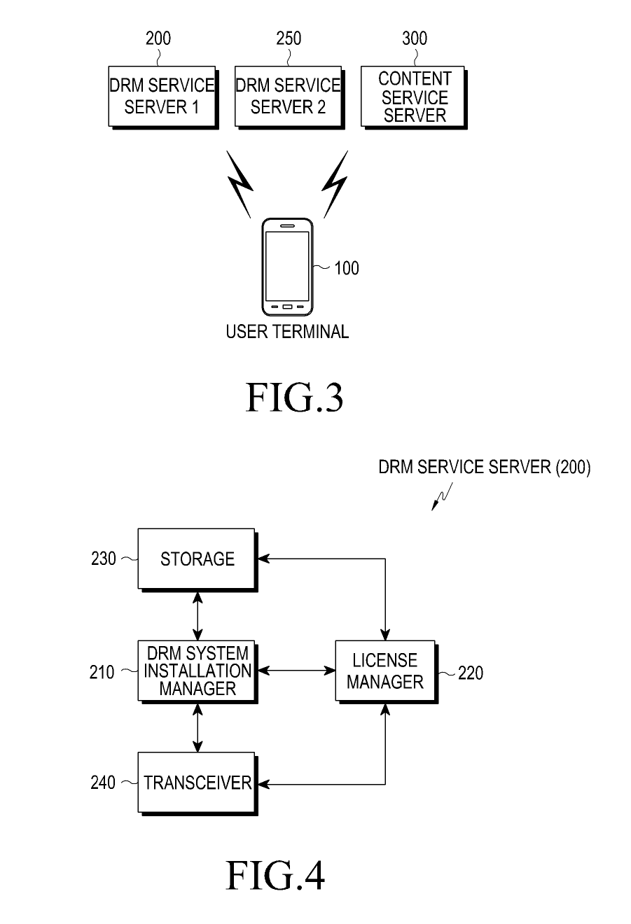

FIG. 3 illustrates a configuration of a DRM service system, according to an embodiment of the present invention.

Referring to FIG. 3, the DRM service system includes a user terminal 100, a first DRM service server 200, a content service server 300, and a second DRM service server 250.

The content service server 300 is a device for providing various digital content to user terminals having subscribed to its multimedia service and managing information about users and user terminals having subscribed to the service. The content service server 300 may provide an adaptive streaming service. The content service server 300 may provide information about one or more DRM systems applied to the adaptive streaming service, to the user terminal 100.

Each of the first and second DRM service servers 200 and 250 is a device for generating and managing a license corresponding to individual content in association with the content service server 300, and providing the license to user terminals. The license is data having the information that specifies an encryption key used to decrypt encrypted DRM content, and access rights (e.g., the number of accesses, period, access conditions, etc.) to DRM content. The first and second DRM service servers 200 and 250 provide user terminals with a DRM system module capable of installing a DRM agent corresponding to a DRM system used to generate a license.

It is assumed that the first and second DRM service servers 200 and 250 are similar in operation proposed by the present invention except that they support different DRM systems. For example, the first DRM service server 200 may be a server device supporting an OMA DRM system, while the second DRM service server 250 may be a server device supporting a Marlin DRM system. Although only the first DRM service server 200 will be described below for simplicity, the same structure and operation will be applied to the second DRM service server 250. In an alternative embodiment of the present invention, one server device may be constructed to include the first and second DRM service servers 200 and 250.

The user terminal 100 is a device for consuming DRM content by requesting, receiving and playing the DRM content. The user terminal 100 may include, for example, a personal computer, a television, a cell phone, a Personal Medial Player (PMP), a music file player, etc.

An example of the first DRM service server 200 is illustrated in FIG. 4. FIG. 4 illustrates a structure of the first DRM service server 200, according to an embodiment of the present invention.

Referring to FIG. 4, the first DRM service server 200 includes a DRM system installation manager 210, a license manager 220, a storage 230, and a transceiver 240.

The transceiver 240 exchanges messages and/or data with the network or other devices, and delivers the received messages and/or data to the DRM system installation manager 210 or the license manager 220. The transceiver 240 transmits the data and messages provided from the DRM system installation manager 210 or the license manager 220 to the related network entities or devices.

The storage 230 stores user information and user terminal information, used to provide the DRM service, and stores programs, reference data, various updatable archival data, etc. used to control the first DRM service server 200. The storage 230 may store a DRM system module capable of installing a DRM agent for the DRM system supported by the first DRM service server 200. For example, an OMA DRM system module may be stored in the storage 230. The storage 230 may also store reference information, based on which the DRM system installation manager 210 may select a DRM system module it will provide to user terminals. The reference information may include, for example, information about the DRM system module available depending on the system performance of user terminals. The storage 230 may store licenses and information required to generate these licenses.

The DRM system installation manager 210 selects DRM system modules to be provided to user terminals at the request of the user terminals, and controls delivery of the selected DRM system modules.

The license manager 220 generates and manages a license corresponding to individual content in association with the content service server 300. More specifically, the license manager 220 generates and manages a license in response to a generation request for a license corresponding to specific content from the content service server 300.

In accordance with an embodiment of the present invention, a license applied to specific content may be generated according to various different generation patterns. Examples of the license generation patterns are described in detail below.

A license applied to specific content may be generated to correspond to each of multiple DRM systems of different types. Specifically, a license including the same encryption key and access rights to the same content may be generated depending on the scheme of each of multiple DRM systems.

Also, in accordance with an embodiment of the present invention, when an adaptive streaming service is provided, a license corresponding to each of multiple DRM systems may be generated for each period of the content. Specifically, the entire length of specific content may be divided into multiple periods, and a license corresponding to each of the periods may be generated depending on the scheme of each of the multiple DRM systems. Although the encryption key and the access rights to content, included in each of multiple licenses corresponding to a specific period, are the same, information included in the licenses corresponding to each period may be either the same or different.

When an adaptive streaming service is provided, a license corresponding to each of multiple DRM systems may also be generated individually depending on the network bandwidth, i.e., the bitrate of streaming data. Content quality may be differentiated by providing specific content with multiple bitrates in providing the adaptive streaming service. Accordingly, a license is generated for each network bandwidth corresponding to each bitrate individually depending on the scheme of each of the multiple DRM systems. Although the encryption key and the access rights to content, included in each of multiple licenses corresponding to a specific network bandwidth, are the same, information included in the licenses corresponding to each network bandwidth may be either the same or different.

A license including different information may be generated depending on the user subscription level granted to a user terminal scheduled to receive content. A license corresponding to each user subscription level may also be generated to correspond to the schemes of multiple DRM systems. An encryption key included in a license corresponding to a high user subscription level may be configured to make it possible to calculate an encryption key included in a license corresponding to a low user subscription level.

A generation pattern for a license corresponding to specific content may be determined by the content service server 300, and the illustrated license patterns may be used in a mixed way.

By generating a license for each period of specific content data individually depending on the network bandwidth of the period or the subscription level, it is possible to apply multiple DRM systems to each representation corresponding to specific content.

Referring again to FIG. 3, the DRM system installation manager 210 delivers content protection information for individual content to the content service server 300. The content protection information, which includes information about multiple licenses generated to correspond to specific content as described above, may include content information, DRM identification information, and license acquisition information. In addition, DRM information may selectively include DRM download information or a license itself.

The content information may include identification information for content associated with the license, and identification information for a generation pattern corresponding to the license. For example, if a license is generated depending on the specific period and the specific network bandwidth of specific content data, the content information may include identification information for the specific content, identification information for the specific period, and identification information for the specific network bandwidth. In another example, if a license is generated depending on the subscription level, the content information may include identification information for the subscription level.

The DRM identification information is identification information for a DRM system used to generate the license.

The license acquisition information is information related to the location where a user terminal may download the license.

The DRM download information is information related to the location where a user terminal may download a DRM system module corresponding to the DRM system used to generate the license.

The content service server 300 changes the content protection information received from the first and second DRM service servers 200 and 250 into the format that user terminals may handle, and transmits the resulting information to the user terminals. In an embodiment of the present invention, it will be assumed that the content protection information is delivered to the user terminals using MPD information. In accordance with an embodiment of the present invention, the content protection information may be generated to be included in an MPD level of MPD information, or may be generated to be included in representation information. An example of this MPD information will be described in greater detail below.

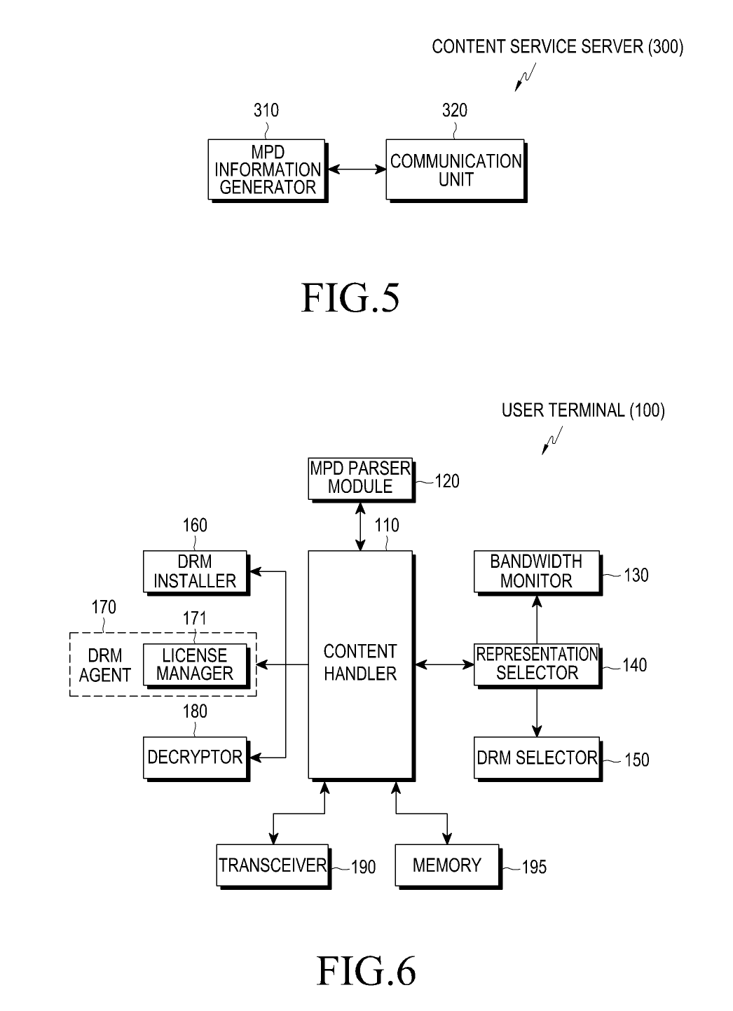

FIG. 5 is a diagram illustrating a structure of the content service server 300, according to an embodiment of the present invention. The content service server 300 may include an MPD information generator 310 having content protection information, and a communication unit 320 for exchanging various data with the user terminal 100 and/or the first and second DRM service servers 200 and 250. The MPD information generator 310 changes the content protection information received from the first and second DRM service servers 200 and 250 into the format that user terminals may handle, and includes the resulting information in the MPD information described in greater detail below.

FIG. 6 illustrates a structure of the user terminal 100, according to an embodiment of the present invention.

Referring to FIG. 6, the user terminal 100 includes a content handler 110, an MPD parser module 120, a bandwidth monitor 130, a representation selector 140, a DRM selector 150, a DRM installer 160, a DRM agent 170, a decryptor 180, a transceiver 190, and a memory 195.

The content handler 110 performs the functions of the user terminal 100 by controlling the following components.

The transceiver 190 exchanges messages and/or data with the network or other devices. The transceiver 190 delivers the received messages and/or data to the content handler 110, and transmits the data and/or messages provided from the content handler 110 to the network entities or devices.

The memory 195 stores programs, reference data, various updatable archival data, etc., used to handle and control the user terminal 100.

The MPD parser module 120, under control of the content handler 110, generates a DRM object for content protection information by parsing an MPD node of the MPD information that is received from the content service server 300 through the transceiver 190. The MPD parser module 120 delivers the parsed MPD information to the content handler 110. The content handler 110 delivers the MPD information to the representation selector 140.

The bandwidth monitor 130 checks a network bandwidth by monitoring the network state, and delivers it to the representation selector 140, thereby providing the criteria for representation selection.

The DRM selector 150 selects a proper DRM system to be used to play the content to which multiple DRM systems are applied, based on the information about the installation of the DRM system of the user terminal 100, the performance of the user terminal 100, and the DRM selection criteria. The DRM selection criteria may be set in various different ways. For example, the DRM selection criteria may include at least one of the DRM system presently installed in the user terminal 100, the DRM system preferred by the service provider providing content, and the DRM system preferred by the user.

The representation selector 140 selects a representation of a proper level by referring to and comparing the network bandwidths, the DRM selection criteria, and information about one or more representations included in the MPD information.

The information about the DRM system determined by the DRM selector 150, and the information about the representation selected by the representation selector 140 are delivered to the content handler 110.

The DRM installer 160, under control of the content handler 110, downloads and installs a DRM system module, if a DRM agent corresponding to the DRM system selected by the DRM selector 150 is not installed in the user terminal 100. The DRM installer 160 may proceed with a procedure for authenticating the first and second DRM service servers 200 and 250 by generating performance information and security verification information of the user terminal 100. The DRM agent 170, under control of the content handler 110, performs a protocol for acquiring a license, and allows the content to be played according to the acquired license. Specifically, the DRM agent 170 acquires a license by its license manager 171 and manages the acquired license. Based on the access rights included in the license, the DRM agent 170 allows the content to be played by the user terminal 100, and delivers the encryption key included in the license to the decryptor 180.

The DRM agent 170 is distinguishable according to the type of the DRM system, and other DRM agents may be added by the DRM installer 160.

The decryptor 180, under control of the content handler 110, decrypts the encrypted content data based on the encryption key information in the license, and the encryption information (e.g., an initial vector and an encryption algorithm) described in the MPD information. The decrypted content data is played by a multimedia player under control of the content handler 110.

A configuration of MPD information, an operation of the user terminal 100, and a sequence protocol between the user terminal 100 and the servers 200, 250 and 300 is described in detail below according to an embodiment of the present invention.

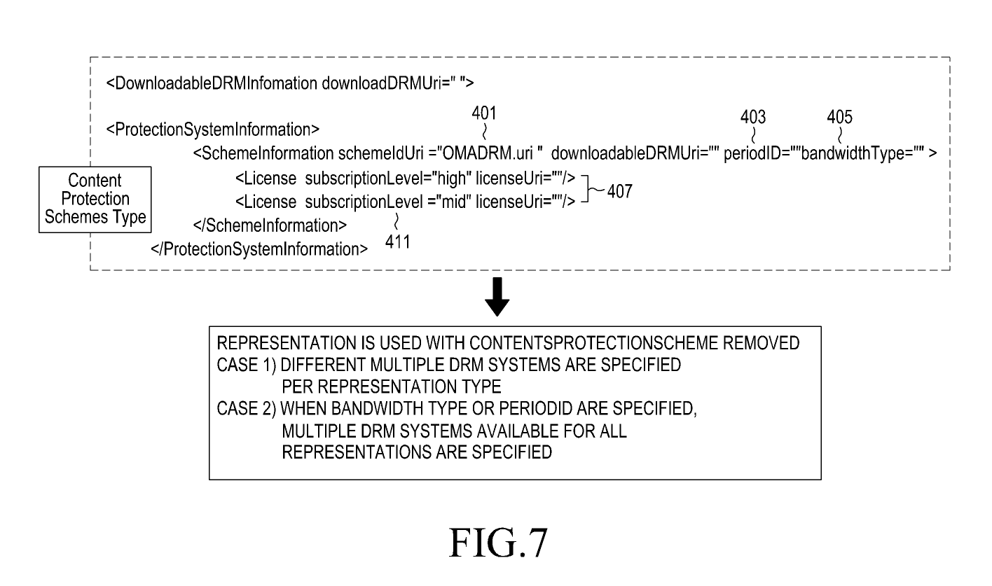

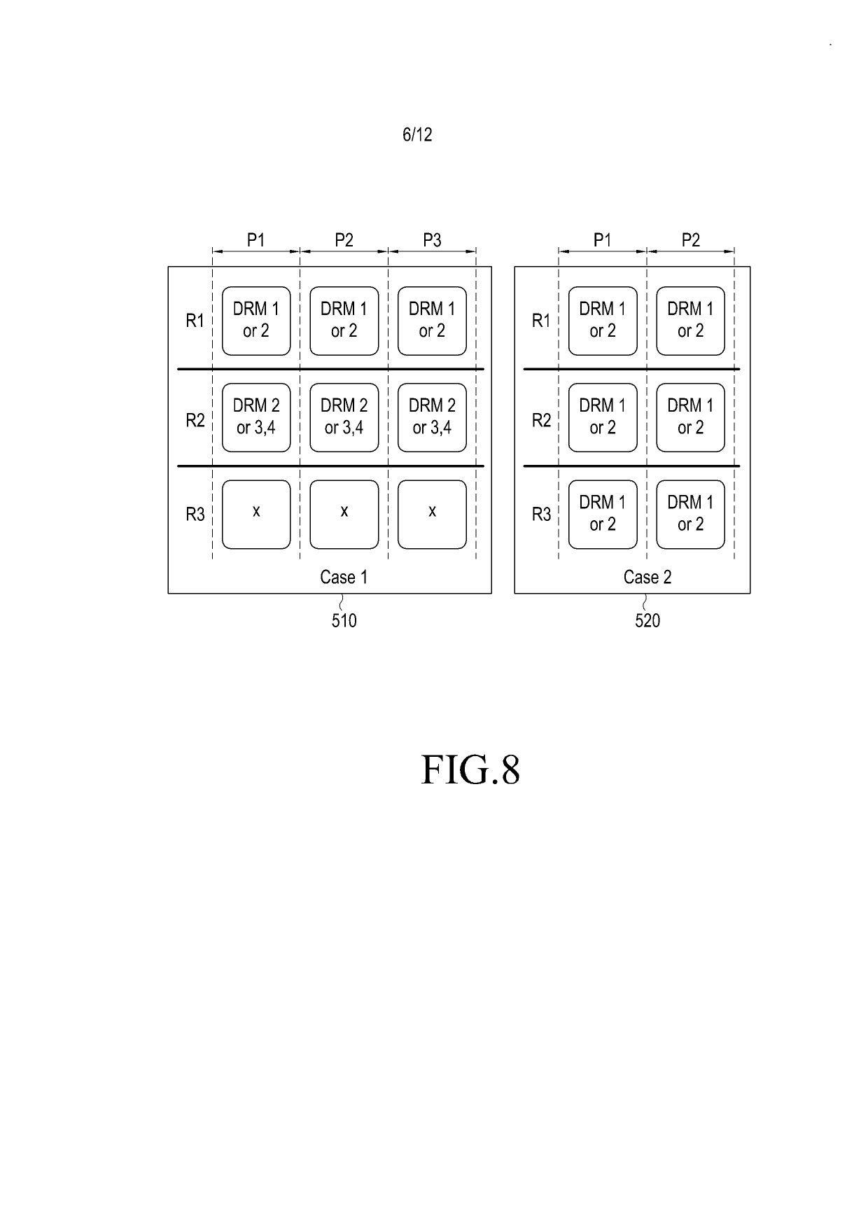

FIGS. 7 and 8 illustrate a method of providing multiple DRM systems when content protection information is included in an MPD level of MPD information, according to an embodiment of the present invention. Specifically, FIG. 7 illustrates content protection information represented in a top node of MPD information, according to an embodiment of the present invention. FIG. 8 illustrates an example of multiple DRM systems applied to an adaptive streaming service for specific available content, according to an embodiment of the present invention.

In FIG. 7, content protection information ‘content protection schemes type’ of MPD information includes DRM identification information, DRM download information, period identification information, network bandwidth identification information, subscription level identification information, and license acquisition information. The period identification information, the network bandwidth identification information, and the subscription level identification information are information capable of representing a generation pattern for a license. Based on the information, the user terminal 100 may identify information about the DRM system applied to each representation.

In the embodiment of the present invention shown in FIG. 7, information about the subsequent representations may include no separate content protection information, because the top node of MPD information provides the content protection information.

The MPD information in FIG. 7 may be an example of content protection information ‘content protection schemes type’ when an OMA DRM system is used and a license is generated separately based on the period, the network bandwidth, and the subscription level of content data. When another DRM system, for example, a Marlin DRM system or a Widevine DRM system, is also applied, information about the DRM system may also be represented in the MPD information in a similar form.

Attributes supporting the above information are described in detail below.

The DRM identification information is represented by “schemeIdUri” 409, which provides identification information of the DRM system used to generate a license.

The DRM download information is represented by “downloadableDRMURI” 401, which provides URI information of a DRM system module so that a user terminal may download and install a DRM system module when it does not presently support the related DRM.

The period identification information is represented by “periodlD” 403, and the network bandwidth identification information is represented by “bandwidthType” 405. Each of the attributes 403 and 405 provides a link attribute so as to install the DRM system related to the content in units of a period of specific content data, or in units of a network bandwidth (bitrate) type thereof. Specifically, the attributes 403 and 405 specify information about the period and the network bandwidth of the content data, to which a license used in the OMA DRM system is applied.

If the “periodID” 403 and the “bandwidthType” 405 are not specified, it indicates that the DRM system was not applied on a period basis or a network bandwidth basis.

The license acquisition information is represented by “licenseUri” 411, which indicates identification information by which a license may be acquired, or indicates the location where a license is stored.

The subscription level identification information is represented by “subscriptionLevel” 407, which is used when a different license is issued depending on the user subscription level. In the embodiment of the present invention shown in FIG. 7, licenses corresponding to a “high” level and a “mid” level exist independently.

Case #1 510 in FIG. 8 indicates a case where multiple DRM systems are applied to specific content per each of network bandwidths R1, R2 and R3, and periods P1, P2 and P3. Specifically, in Case #1 510, when streaming data of specific content is provided over a first network bandwidth R1, a first DRM system DRM1 or a second DRM system DRM2 is applied to each of the periods P1, P2 and P3. When the streaming data is provided over a second network bandwidth R2, the second DRM system DRM2, a third DRM system DRM3 or a fourth DRM system DRM4 is applied to each of the periods P1, P2 and P3. When the streaming data is provided over a third network bandwidth R3, no DRM system is applied, meaning that the content is provided without being encrypted.

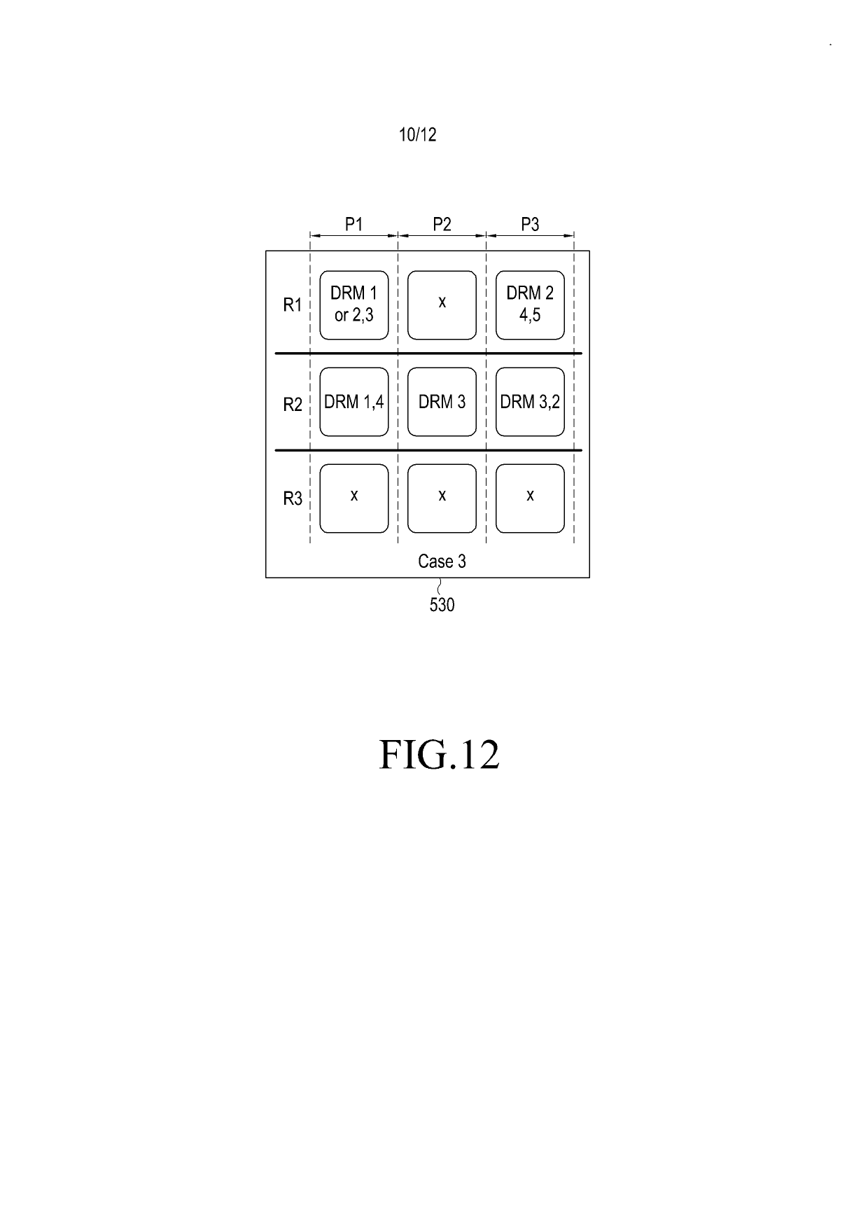

In each of cases 510, 520 and 530 (of FIG. 12), it is assumed that a first network bandwidth R1 is broadest, while a third network bandwidth R3 is narrowest.

Accordingly, the user terminal 100 may play specific content without acquiring a license, if it can receive streaming of the specific content over the third network bandwidth R3.

If the user terminal 100 can receive the streaming over the second network bandwidth R2, the user terminal 100 may play content by acquiring a license generated depending on any one of the second DRM system DRM2, the third DRM system DRM3, and the fourth DRM system DRM4. Assuming that the DRM agent 170 in the user terminal 100 supports the fourth DRM system DRM4, the user terminal 100 will acquire a license corresponding to the fourth DRM system DRM4.

Under the same assumption, if the user terminal 100 can receive the streaming over the first network bandwidth R1, the user terminal 100 may play content by acquiring a license generated depending on any one of the first DRM system DRM1 and the second DRM system DRM2. However, since the DRM agent 170 supports the fourth DRM system DRM4, the user terminal 100 downloads a DRM system module corresponding to any one of the first DRM system DRM1 and the second DRM system DRM2, installs its associated DRM agent, and plays specific content using this DRM agent by acquiring a required license.

Case #2 520 indicates a case where two DRM systems are applied to specific content regardless of the period or the network bandwidth of streaming data. Specifically, a license corresponding to specific content is generated to correspond to each of the first DRM system DRM1 and the second DRM system DRM2. When the security requirement is different according to the type of the network bandwidth or the bitrate, an embodiment of the present invention may be utilized as described below.

Embodiments of the present invention provide technology in which the content provider may apply content protection systems whose security levels are different according to the types of bitrates, i.e., the content qualities (e.g., a Standard Definition (SD) class, a High Definition (HD) class, and a Full HD class).

In Step 1, the content service server 300 specifies a bitrate “bandwidthType” representing network bandwidth identification information in content protection information in the MPD information, as shown in Table 1 below.

TABLE 1
<ProtectionSystemInformation>
<SchemeInformationschemeIdUri=“Marlin.uri”downloadableDRMUri=“”bandwidthType=“h
igh”/>
<SchemeInformationschemeIdUri=“OMADRM.uri”downloadableDRMUri=“”bandwidthTyp
e=“mid”/>
<SchemeInformationschemeIdUri=“playready”downloadableDRMUri=“”bandwidthType=“lo
w”/>
<ProtectionSystemInformation>

In Step 2, the user terminal 100 downloads and installs the related DRM system module, decrypts representations of each period using a license URI and segment encryption information of the DRM system designated depending on the network bandwidth state, and plays the decrypted content.

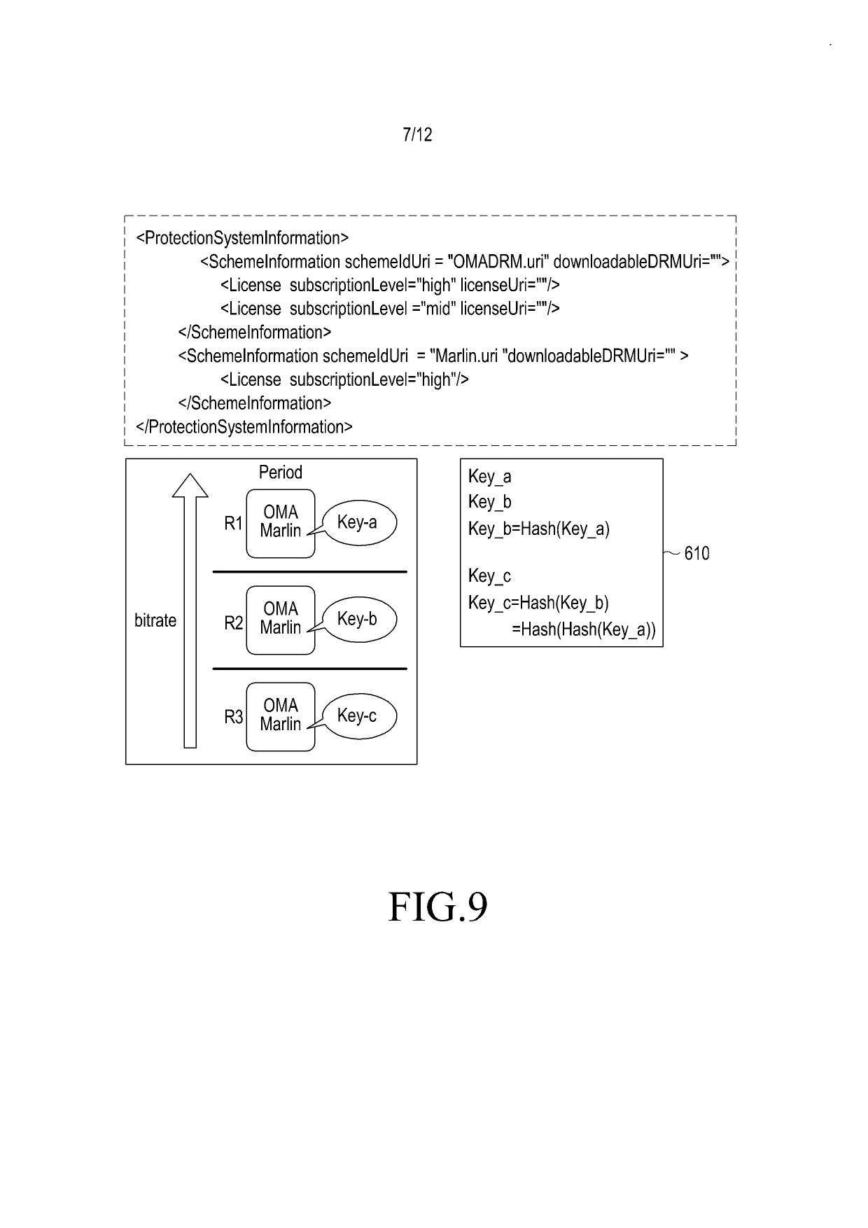

FIG. 9 illustrates a method for managing encryption keys depending on the bitrate or the subscription level, according to an embodiment of the present invention.

In accordance with an embodiment of the present invention, for the same content, when a license is acquired for high-quality streaming data, an encryption key may be configured and managed so as to make it possible to extract an encryption key capable of decrypting low-quality streaming data from an encryption key included in the acquired license. The use criteria for high-quality content and low-quality content may include the network bandwidth or the subscription level.

For example, FIG. 9 illustrates Case #2 520 of FIG. 8, in which the first DRM system DRM1 is an OMA DRM system while the second DRM system DRM2 is a Marlin DRM system.

Referring to FIG. 9, although streaming data of specific content is applied the OMA DRM system and the Marlin DRM system in a specific period regardless of the network bandwidths R1, R2 and R3, encryption keys key_a, key_b, and key_c included in licenses corresponding to the network bandwidths R1, R2 and R3 are different from one another. Specifically, an encryption key corresponding to the first network bandwidth R1 is key_a, an encryption key corresponding to the second network bandwidth R2 is key_b, and an encryption key corresponding to the third network bandwidth R3 is key_c.

If a subscription level is “mid”, a license, from which key_b can be calculated as illustrated in FIG. 9, may not be acquired. If a server device provides encryption keys by managing keys using a hash chain as in Equation (1) below and 610 of FIG. 9, a subscription level of “mid” may make it possible to decrypt even the encrypted streaming data corresponding to representations whose bitrates are lower than that of the subscription level of “mid”.

Key_a,

Key_{—}b=Hash(Key_{—}a),

Key_{—}c=Hash(Key_{—}b)=Hash(Hash(Key_{—}a)) (1)

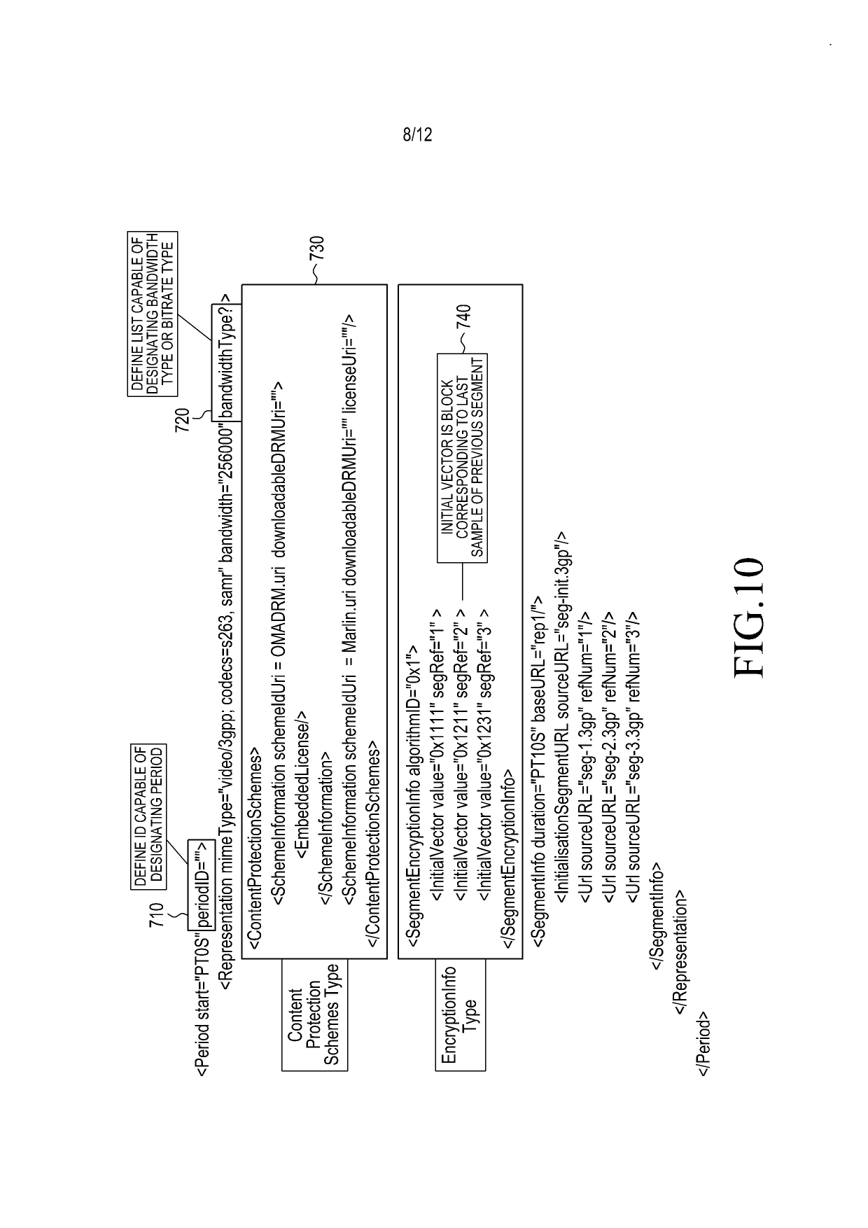

An example of applying multiple DRM systems on a representation basis and specifying content protection information in representation information in MPD information is described in detail below with reference to FIGS. 10 to 12.

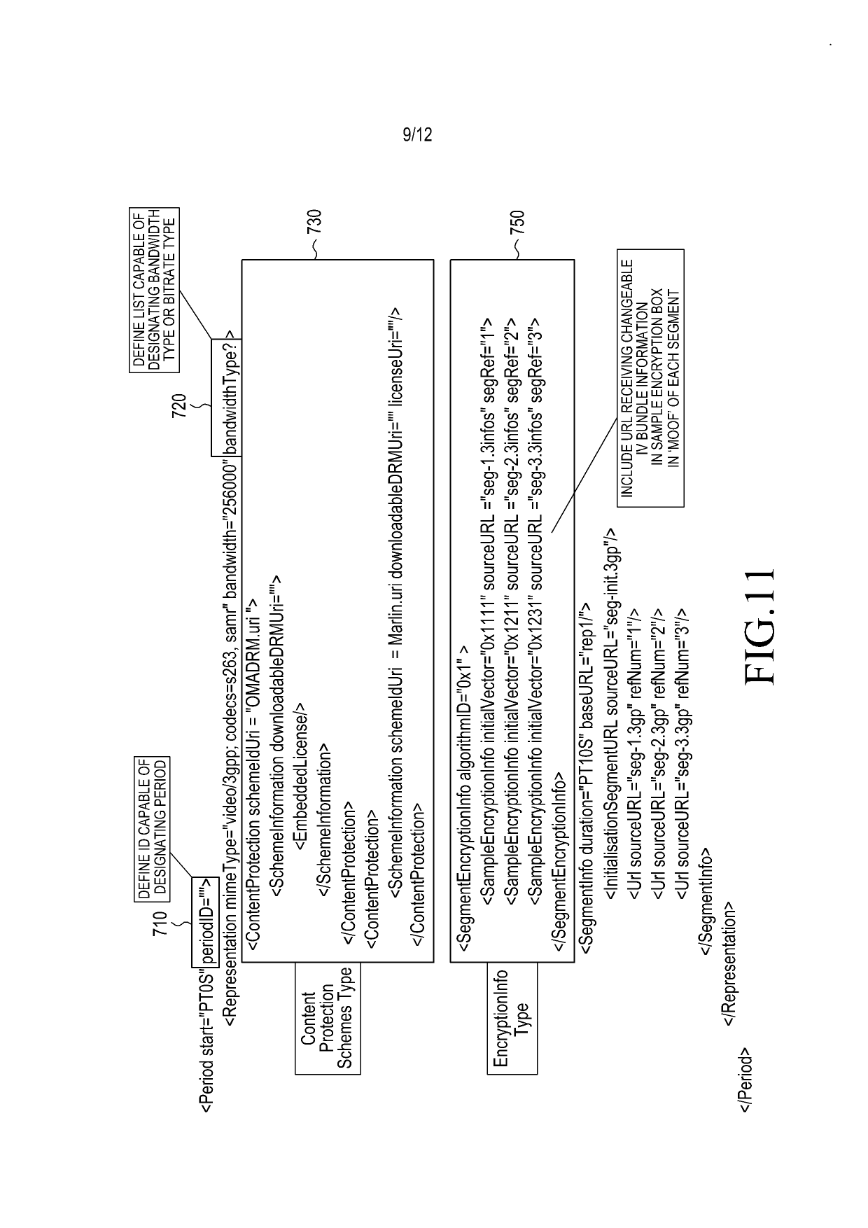

FIGS. 10 and 11 illustrate examples of MPD information for supporting multiple DRM systems on a representation basis, according to an embodiment of the present invention. FIG. 12 illustrates an example of supporting multiple DRM systems on a representation basis and a period basis, according to the embodiment of the present invention shown in FIGS. 10 and 11.

For decryption of encrypted segments, information about an applied algorithm, an initial vector, etc. should be provided together. In FIGS. 10 and 11, period identification information corresponding to a representation, to which its representation information is applied, is represented by “periodlD” 710, and network bandwidth identification information is represented by “bandwidthT” 720.

Content protection information 730 includes DRM identification information “schemeldUri”, DRM download information “downloadableDRMURI”, and license acquisition information “licenseUri”.

Representation information in FIGS. 10 and 11 include encryption information “Encryption Info type” 740 and 750, respectively. For decryption of encrypted segments, the encryption information includes information about an applied algorithm, an initial vector, etc.

In FIG. 10, an initial vector is provided as segment-by-segment encryption information ‘Encryption Info’ 730. Encrypting only the data classified as samples, except for the meta information, in segments with a segment-by-segment algorithm and an initial vector application method is used as an implicit rule. An initial value except for the initial vector of a first segment means a ciphertext value for the final block of the last sample of the previous segment. This performs a function of providing information so as to make it possible to quickly perform random access on a segment basis.

In FIG. 11, sample-by-sample encryption information ‘Encryption Info’ 750 is provided, in which a link for acquiring an initial vector bundle is specified. This method of applying initial vectors in units of sample data in segments is a specific method of acquiring information corresponding to an initial vector bundle based on a URI when the number of samples is large or unspecified. The embodiments of the present invention enable sample-by-sample random access even for the encrypted streaming data because it calculates initial vectors on a sample basis. By specifying an initial vector in “SampleEncryptionInfo” instead of URI as an attribute, a method may be provided in which a client performs segment-level decryption by parsing MPD information without access to additional URIs.

Embodiments of the present invention may be applied to technologies such as recording (storing and converting) of streaming data, because it is consistent with the existing file format (PIFF by MS company) supporting multiple DRM systems.

Additional elements and attributes of the embodiments of the present invention are described in greater detail below.

“LicenseUri” represents a URI where a client may acquire a license for obtaining a content encryption key.

“EmbeddedLicense” indicates that DRM-specific license information is included or embedded in MPD information, unlike “LicenseUri” that causes the client to acquire a license using an external URI.

The pair of “segRef” and “refNum” provide a link indicating to which segment the initial vector and the “SampleEncryptionInfo” correspond.

Case #3 530 illustrated in FIG. 12 represents a case where multiple DRM systems are applied to specific content, for each of the network bandwidths R1, R2 and R3, and the periods P1, P2 and P. Specifically, in Case #3 530, when streaming data of specific content is provided over the first network bandwidth R1, any one of a first DRM system DRM1, a second DRM system DRM2 and a third DRM system DRM3 is applied to the first period P1. Content data of the second period P2 is provided without being encrypted. Any one of the second DRM system DRM2, a fourth DRM system DRM4 and a fifth DRM system DRM5 is applied to the third period P3.

When the streaming data is provided over the second network bandwidth R2, any one of the first and fourth DRM systems DRM1 and DRM4 is applied to the first period P1, the third DRM system DRM3 is applied to the second period P2, and any one of the second DRM system DRM2 and the third DRM system DRM3 is applied to the third period P3.

When the streaming data is provided over the third network bandwidth R3, no DRM system is applied, meaning that the content is provided without being encrypted.

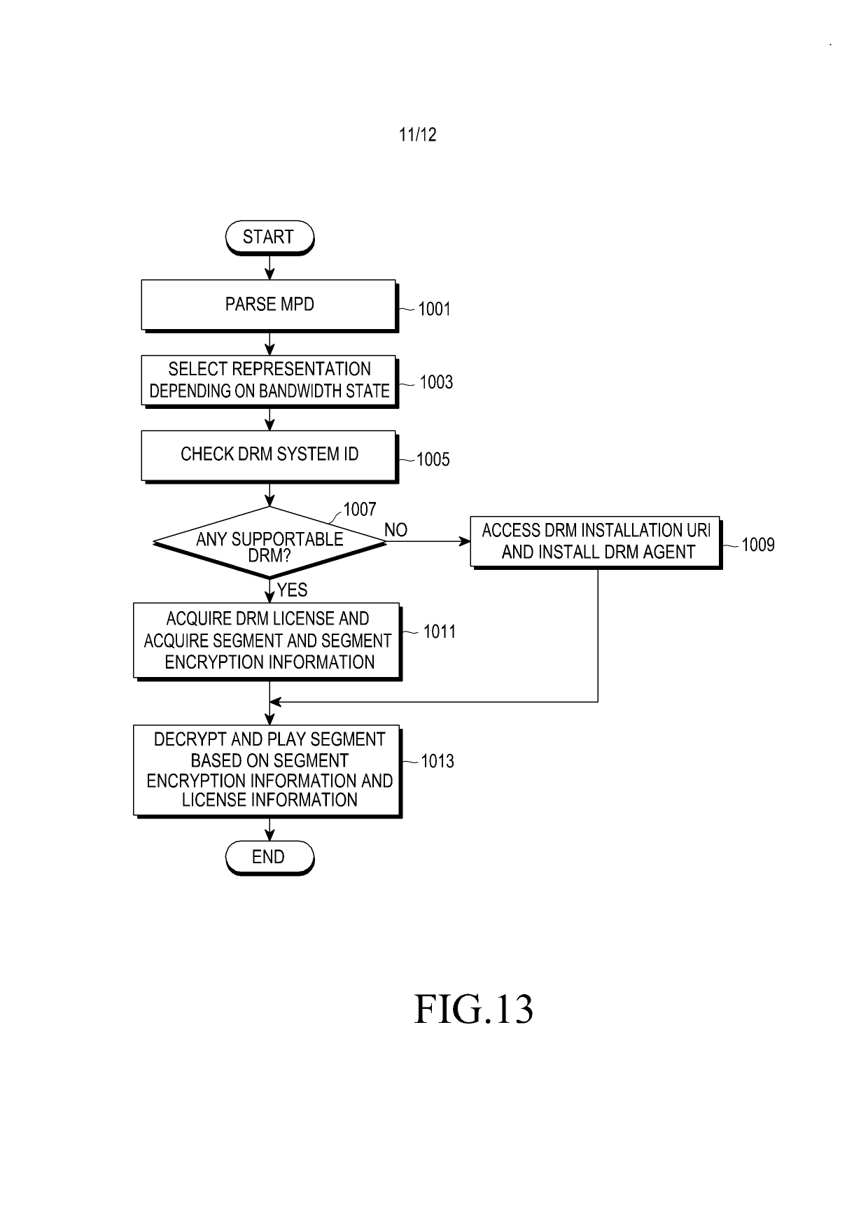

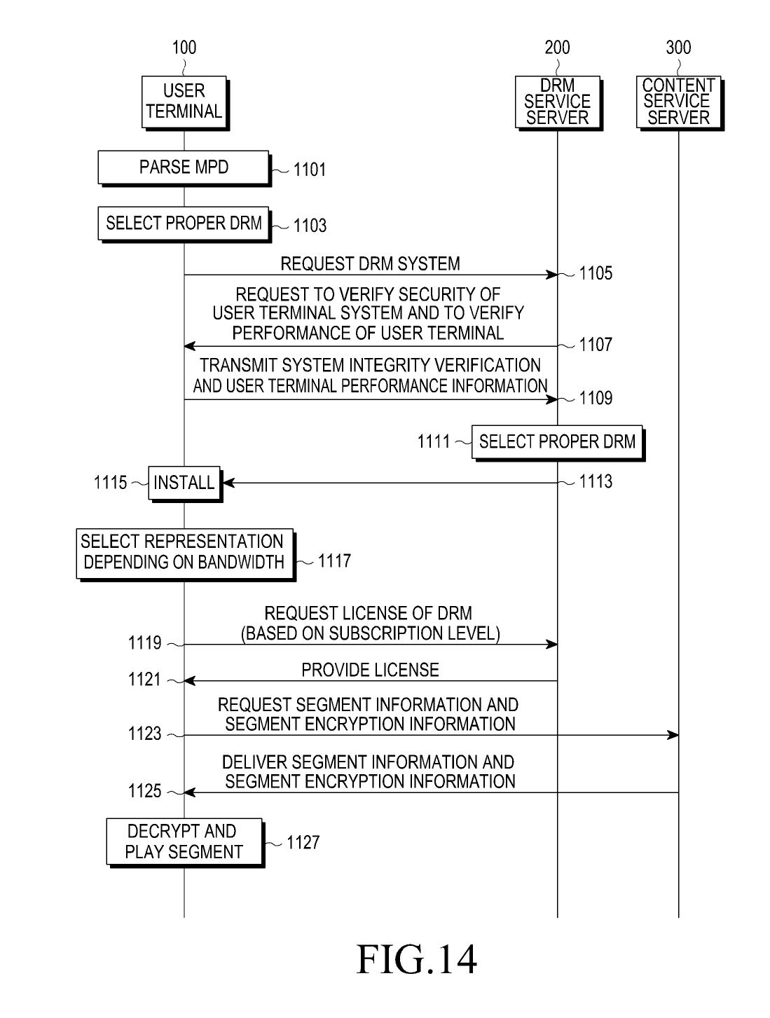

FIG. 13 illustrates a flow of a task performed in the user terminal 100, according to an embodiment of the present invention. FIG. 14 illustrates a protocol or sequence diagram among the user terminal 100, the first DRM service server 200, and the content service server 300, according to an embodiment of the present invention.

In FIG. 13, the user terminal 100 acquires content protection information by MPD parsing, and selects a representation depending on the network bandwidth and as to whether it supports DRM systems.

The user terminal 100 parses MPD information received from the network through its MPD parser module 120 in step 1001. As described above, the MPD information includes content protection information. The content protection information may be included in the top node of the MPD information, and may also be included in information about each representation.

In step 1003, the user terminal 100 selects a proper representation depending on the MPD information and the current network bandwidth state. Specifically, the user terminal 100 selects a receivable representation by comparing the current network bandwidth monitored by its bandwidth monitor 130 with the presentation information included in the MPD information.

In step 1005, the DRM selector 150 in the user terminal 100 checks the type of the DRM system(s) applied to the selected representation. In step 1007, the DRM selector 150 determines if a DRM system supportable by the user terminal 100 exists among the DRM systems applied to the selected representation.

If a supportable DRM system exists, the DRM selector 150 determines an available DRM system and acquires a license by means of the DRM agent 170 in step 1011. For example, if the DRM system supportable by the user terminal 100 includes one specific DRM system, this specific DRM system will be determined as a using DRM system. However, if multiple DRM system are supportable by the user terminal 100, a using DRM system will be determined depending on the predetermined selection criteria, for example, the user preference, the preference of the service provider, and the use frequency.

After acquiring the license, the user terminal 100 acquires a segment and segment encryption information of the selected representation from the content service server 300 in step 1011, and then proceeds to step 1013.

If it is determined in step 1007 that there is no supportable DRM system, the DRM selector 150 in the user terminal 100 determines a downloadable DRM system from among the DRM systems applied to the selected representation, in step 1009. Specifically, the user terminal 100 checks DRM download information included in representation information corresponding to the selected representation. The user terminal 100 downloads a DRM system module based on this information, and installs the related DRM agent, which in this case becomes a using DRM system.

In step 1013, the user terminal 100 decrypts and plays the segment acquired in step 1011 based on the segment encryption information and the license information.

Although an example of selecting a representation, and then determining (selecting) a DRM system to be used from among multiple DRM systems corresponding to the selected representation has been described so far, alternative embodiments of the present invention may be provided to first determine a using DRM system, and then select a representation to which the using DRM system is applied. FIG. 14 shows an example of an alternative embodiment.

A DRM system(s) may be installed through access to servers as illustrated in FIG. 14. A user terminal may acquire a license related to the selected DRM system, decrypt the segment based on the encryption information ‘Encryption Info’, and play content. The user terminal may select a representation after selecting the DRM system.

Referring to FIG. 14, the user terminal 100 receives MPD information transmitted by the content service server 300, and parses the MPD information in step 1101. In step 1103, the user terminal 100 determines DRM systems applied to specific content it desires to use by checking content protection information included in the MPD information, and selects a DRM system appropriate for the user terminal 100.

For example, if it is determined that a DRM system supported by the user terminal 100 exists among the DRM systems applied to specific content, the user terminal 100 selects the DRM system as the DRM system it will use in playing the specific content. The user terminal 100 selects a representation supportable in the monitored network bandwidth from among the representations to which the selected DRM system is applied.

If no DRM system supported by the user terminal 100 exists among the DRM systems applied to specific content, the user terminal 100 may determine a DRM system it will download, based on the DRM download information included in the content protection information, and acquire a DRM system module. In FIG. 14, the user terminal 100 downloads a DRM system module. In step 1105, the user terminal 100 sends a download request message for a DRM system module to the first DRM service server 200.

Upon receiving the download request message for a DRM system module from the user terminal 100, the first DRM service server 200 sends a request message for user terminal system security verification and user terminal performance verification to the user terminal 100, in step 1107. The request message allows the DRM service server 200 to determine if the user terminal 100 is a terminal capable of downloading and installing a DRM system module, and to provide a proper DRM system module to the user terminal 100.

Upon receiving the request message for user terminal system security verification and user terminal performance verification, the user terminal 100 sends a response message including system integrity verification information and user terminal performance verification information to the first DRM service server 200, in step 1109.

In step 1111, the first DRM service server 200 checks the system integrity verification information and the user terminal performance verification information of the user terminal 100, and selects a DRM system module appropriate for the user terminal 100. For example, the first DRM service server 200 may select a proper version of the DRM system module depending on the performance of the user terminal 100. In step 1113, the first DRM service server 200 provides the DRM system module to the user terminal 100. In step 1115, the user terminal 100 receives and installs the DRM system module. Accordingly, the user terminal 100 may install a DRM agent capable of using the DRM service that the first DRM service server 200 provides.

In step 1117, the user terminal 100 selects a proper representation based on the representation information in the MPD information and the monitored network bandwidth information. In step 1119, the user terminal 100 sends a request for a license to be applied to the selected representation, to the first DRM service server 200. A subscription level may be referenced in this request for a license.

In step 1121, the first DRM service server 200 provides the requested license to the user terminal 100.

Upon receiving the requested license, the user terminal 100 sends a request for segment information and segment encryption information corresponding to the selected representation to the content service server 300 in step 1123. In step 1125, the content service server 300 provides the requested segment information and segment encryption information to the user terminal 100.

In step 1127, the user terminal 100 decrypts and plays the segment of specific content based on the license acquired in step 1121.

Embodiments of the present invention may provide content supporting multiple DRM systems in providing an adaptive streaming service. Furthermore, the embodiments of the present invention may provide a method and apparatus capable of decrypting and playing encrypted streaming data when no DRM system is installed in a user terminal. In addition, the embodiments of the present invention may provide a method and apparatus capable of securely ensuring a wider variety of content distribution by making it possible to designate different DRM systems to meet different security requirements depending on the content qualities.

As is apparent from the foregoing description, an embodiment of the present invention may provide a method and apparatus capable of applying multiple DRM systems and inserting and extracting information required for decryption in providing an adaptive streaming service.

An embodiment of the present invention may provide a user terminal apparatus for playing adaptive streaming data supporting multiple DRM systems.

An embodiment of the present invention may provide a method and apparatus for selecting a representation taking into account a network bandwidth and a downloadable DRM system, verifying performance of a client to decrypt protected streaming data, requesting download of a proper DRM system, installing the DRM system, acquiring a license, decrypting streaming data based on the acquired license and description information, and playing content.

An embodiment of the present invention may provide a method and apparatus capable of acquiring a different license depending on a subscription level of a user in providing an adaptive streaming service.

An embodiment of the present invention may provide an encryption key management method for allowing a user terminal to decrypt a representation over all bitrates once it acquires a license whose subscription level is highest.

While the invention has been shown and described with reference to certain embodiments thereof, it will be understood by those skilled in the art that various changes in form and detail may be made therein without departing from the spirit and scope of the invention as defined by the appended claims and their equivalents.

What is claimed is:

1. A method for providing a Digital Rights Management (DRM) service in a user terminal apparatus providing an adaptive streaming service, the comprising the steps of:
receiving content protection information including information about a plurality of DRM systems applied to specific content provided using the adaptive streaming service;
selecting a specific DRM system from among the plurality of DRM systems;
acquiring a license corresponding to the specific DRM system, wherein the license includes an encryption key capable of decrypting the specific content; and
decrypting the specific content using the acquired license.

2. The method of claim 1, wherein acquiring the license comprises:
downloading a specific DRM system module based on download information included in the content protection information, when the specific DRM system is not identical to a DRM system supported by the user terminal;
installing a DRM agent corresponding to the specific DRM system module using the specific DRM system module; and
acquiring, by the DRM agent, the license based on license acquisition information included in the content protection information.

3. The method of claim 2, wherein selecting the specific DRM system comprises:
checking a receive period in the specific content, which is divided into a plurality of periods in accordance with the adaptive streaming service;
checking types of the plurality of DRM systems applied to the receive period based on the content protection information; and
selecting the specific DRM system from among the plurality of DRM systems applied to the receive period based on a selection criteria.

4. The method of claim 2, wherein selecting the specific DRM system comprises:
checking a current network bandwidth by monitoring a network state;
checking a receive period in the specific content, which is divided into a plurality of periods in accordance with the adaptive streaming service;
selecting a representation supporting the current network bandwidth from among a plurality of representations corresponding to the receive period;
checking types of the plurality of DRM systems applied to the selected representation based on the content protection information; and
selecting the specific DRM system from among the type-checked plurality of DRM systems based on a selection criteria.

5. The method of claim 2, wherein selecting the specific DRM system comprises:
checking a current network bandwidth by monitoring a network state;
checking a receive period in the specific content, which is divided into a plurality of periods in accordance with the adaptive streaming service;
selecting a representation supporting the current network bandwidth and corresponding to a subscription level corresponding to the user terminal apparatus, from among a plurality of representations corresponding to the receive period;
checking types of the plurality of DRM systems applied to the selected representation based on the content protection information; and
selecting the specific DRM system from among the type-checked plurality of DRM systems based on a selection criteria.

6. The method of claim 5, wherein content corresponding to a representation corresponding to a subscription level lower than a subscription level corresponding to the user terminal apparatus among the plurality of representations corresponding to the receive period is played using a second encryption key acquired using the encryption key included in the acquired license.

7. The method of claim 3, wherein the selection criteria comprises at least one of a DRM system of a type supported by the user terminal apparatus, a DRM system preferred by the user terminal apparatus, and a DRM system preferred by a provider of the specific content.

8. The method of claim 2, wherein the content protection information is included in any one of a top node of Multimedia Presentation Description (MPD) information and representation information.

9. A user terminal apparatus for providing an adaptive streaming service and a Digital Rights Management (DRM) service, comprising:
a transceiver for receiving content protection information including information about a plurality of DRM systems applied to specific content provided using the adaptive streaming service;
a DRM selector for selecting a specific DRM system from among the plurality of DRM systems;
a DRM agent for acquiring a license corresponding to the specific DRM system, wherein the license includes an encryption key capable of decrypting the specific content; and
a decryptor for decrypting the specific content using the acquired license.

10. The user terminal apparatus of claim 9, further comprising a DRM installer for downloading a specific DRM system module based on download information included in the content protection information when the specific DRM system is not identical to a DRM system supported by the user terminal, and installing the DRM agent corresponding to the specific DRM system module using the specific DRM system module;
wherein the DRM agent acquires the license based on license acquisition information included in the content protection information.

11. The user terminal apparatus of claim 9, further comprising a representation selector for checking a receive period in the specific content, which is divided into a plurality of periods in accordance with the adaptive streaming service;
wherein the DRM selector checks types of the plurality of DRM systems applied to the checked receive period based on the content protection information, and selects the specific DRM system from among the plurality of DRM systems applied to the receive period based on a selection criteria.

12. The user terminal apparatus of claim 9, further comprising:
a bandwidth monitor for checking a current network bandwidth by monitoring a network state; and
a representation selector for checking a receive period in the specific content, which is divided into a plurality of periods in accordance with the adaptive streaming service, and selecting a representation supporting the current network bandwidth from among a plurality of representations corresponding to the receive period;
wherein the DRM selector checks types of the plurality of DRM systems applied to the selected representation based on the content protection information, and selects the specific DRM system from among the type-checked plurality of DRM systems based on a selection criteria.

13. The user terminal apparatus of claim 9, further comprising:
a bandwidth monitor for checking a current network bandwidth by monitoring a network state; and
a representation selector for checking a receive period in the specific content, which is divided into a plurality of periods in accordance with the adaptive streaming service, and selecting a representation supporting the current network bandwidth and corresponding to a subscription level corresponding to the user terminal apparatus, from among a plurality of representations corresponding to the receive period;
wherein the DRM selector checks types of the plurality of DRM systems applied to the selected representation based on the content protection information, and selects the specific DRM system from among the type-checked plurality of DRM systems based on a selection criteria.

14. The user terminal apparatus of claim 13, wherein content corresponding to a representation corresponding to a subscription level lower than a subscription level corresponding to the user terminal apparatus among the plurality of representations corresponding to the receive period is played using a second encryption key acquired using the encryption key included in the acquired license.

15. The user terminal apparatus of claim 11, wherein the selection criteria comprises at least one of a DRM system of a type supported by the user terminal apparatus, a DRM system preferred by the user terminal apparatus, and a DRM system preferred by a provider of the specific content.

16. The user terminal apparatus of claim 10, wherein the content protection information is included in any one of a top node of Multimedia Presentation Description (MPD) information and representation information.

17. A method for providing a Digital Rights Management (DRM) service in a content service server that provides an adaptive streaming service, the method comprising the steps of:
generating Multimedia Presentation Description (MPD) information comprising content protection information that includes information about a plurality of DRM systems applied to each of a plurality of representations corresponding to specific content provided using the adaptive streaming service; and
transmitting the MPD information to at least one user terminal apparatus.

18. The method of claim 17, wherein the content protection information comprises identification information for the plurality of DRM systems applied to each of the plurality of plurality of representations, and address information based on which a DRM system module capable of installing a DRM agent corresponding to at least one of the plurality of DRM systems may be downloaded.

19. An apparatus for providing a Digital Rights Management (DRM) service in a content service server providing an adaptive streaming service, comprising:
a Multimedia Presentation Description (MPD) information generator for generating MPD information comprising content protection information that includes information about a plurality of DRM systems applied to each of a plurality of representations corresponding to specific content provided using the adaptive streaming service; and
a communication unit for transmitting the MPD information to at least one user terminal apparatus.

20. The apparatus of claim 19, wherein the content protection information comprises identification information for the plurality of DRM systems applied to each of the plurality of representations, and address information based on which a DRM system module capable of installing a DRM agent corresponding to at least one of the plurality of DRM systems may be downloaded.
